(19) United States
(12) Patent Application Publication
(10) Pub. No.: US 2017/0242597 A1
(43) Pub. Date: Aug. 24, 2017

(54) WEAR LEVELING METHOD, MEMORY CONTROL CIRCUIT UNIT AND MEMORY STORAGE DEVICE

(71) Applicant: PHISON ELECTRONICS CORP., Miaoli (TW)

(72) Inventor: Jyun-Kai Huang, Taoyuan City (TW)

(21) Appl. No.: 15/080,564

(22) Filed: Mar. 24, 2016

(30) Foreign Application Priority Data
Feb. 19, 2016 (TW) 105104867

(51) Int. Cl. G06F 3/06

(52) U.S. Cl. CPC G06F 3/0616; G06F 3/0652; G06F 3/0679

(57) ABSTRACT

A wear leveling method, a memory control circuit unit and a memory storage device are provided. The method includes: selecting a first physical erasing unit from physical erasing units not stored with valid data according to erase counts, and selecting a second physical erasing unit having a valid data amount being less than a capacity of one physical erasing unit from the physical erasing units stored with the valid data. The method also includes: selecting a third physical erasing unit having the valid data amount being less than the capacity of one physical erasing unit from the physical erasing units storing valid data according to the erase counts. The method further includes: writing the valid data of the second physical erasing unit and at least part of the valid data of the third physical erasing unit into the first physical erasing unit.

### CROSS-REFERENCE TO RELATED APPLICATION

This application claims the priority benefit of Taiwan application serial no. 105104867, filed on Feb. 19, 2016. The entirety of the above-mentioned patent application is hereby incorporated by reference herein and made a part of this specification.

### BACKGROUND

Technical Field

The present invention relates to a wear leveling method, and more particularly, to a wear leveling method for a rewritable non-volatile memory module, and a memory control circuit unit and a memory storage device using the same.

Description of Related Art

The markets of digital cameras, cellular phones, and MP3 players have expanded rapidly in recent years, resulting in escalated demand for storage media by consumers. The characteristics of data non-volatility, low power consumption, and compact size make a rewritable non-volatile memory module (e.g., a flash memory) ideal to be built in the portable multi-media devices as cited above.

In general, the rewritable non-volatile memory module is used together with a host system. Data to be written into the rewritable non-volatile memory module includes data belonging to sequential addresses and data belonging to non-sequential addresses. Accordingly, in correspondence to the different write-in data, a write operation of the rewritable non-volatile memory module may include a sequential write operation and a random write operation. In normal operations, the host system may first write the data belonging to the sequential addresses into a part of physical erasing units in the rewritable non-volatile memory module in a sequential writing manner. Thereafter, the host system changes to write the data belonging to the non-sequential addresses into another part of the physical erasing units in the rewritable non-volatile memory module in a non-sequential writing manner (e.g., the random operation). In normal operations, the probability of the non-sequential write operation performed by host system may be higher than the probability of the sequential write operation being performed. Therefore, after the non-sequential write operation is performed for a while, an erase count of the physical erasing unit in which the data is written by using the non-sequential operation is higher than the erase count of the physical erasing unit in which the data is written by using the sequential write operation. When the difference between the erase counts reaches a certain level, a wear leveling operation of the rewritable non-volatile memory module may be performed on the rewritable non-volatile memory module in order to prevent performance degradation of the entire rewritable non-volatile memory module caused by only parts of the physical erasing units having overly high erase count (in a worst scenario, the rewritable non-volatile memory module may no longer be used at all).

In the wear leveling operation, the physical erasing units requiring the wear leveling operation are decided according to an amount of the erase count. Therefore, after the wear leveling operation is performed for a while, the erase count of the physical erasing unit in which the data is written by using the sequential operation may become close to the erase count of the physical erasing unit in which the data is written by using the non-sequential write operation. After that, during the wear leveling operation, the physical erasing unit in which the data is written by using the sequential operation and the physical erasing unit in which the data is written by using the non-sequential operation may be selected together as the physical erasing units requiring the wear leveling operation. Accordingly, the data originally belonging to the sequential addresses may be written together with the data belonging to the non-sequential addresses into the same physical erasing unit. In this case, during the sequential write operation, an execution speed of the sequential write operation may be lowered since a garbage collection may not be performed effectively, and thus the sequential write operation is unable to maintain at certain execution speed. Based on the above, it is one of the major issues for person skilled in the art as how to prevent the speed of the sequential write operation from being affect by performing the garbage collection.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The present invention is directed to a wear leveling method, a memory control circuit unit and a memory storage device, which are capable of effectively preventing the speed of the sequential write operation from being affected by performing the garbage collection.

According to an exemplary embodiment of the present invention, a wear leveling method for a rewritable non-volatile memory module is provided, wherein the rewritable non-volatile memory module includes a plurality of physical erasing units, and each of the physical erasing units has an identical capacity. The method includes: dividing the physical erasing units into a first group and a second group, wherein the physical erasing units of the first group are not stored with valid data, and the physical erasing units of the second group are stored with the valid data. The method also includes: recording an erase count of each of the physical erasing units and arranging the physical erasing units of the second group according to the recorded erase counts. The method further includes: selecting one physical erasing unit from the physical erasing units of the first group as a first physical erasing unit according to the recorded erase counts, and selecting one physical erasing unit from the physical erasing units of the second group as a second physical erasing unit according to an arrangement sequence of the physical erasing units of the second group, wherein a valid data amount of the second physical erasing unit is less than the capacity. The method further includes: selecting another physical erasing unit having the valid data amount less than the capacity from the physical erasing units of the second group as a third physical erasing unit according to the arrangement sequence of the physical erasing units of the second group, and programming the valid data of the second physical erasing unit and at least part of the valid data of the third physical erasing unit into the first physical erasing unit.

According to an exemplary embodiment of the present invention, a memory control circuit unit for controlling a rewritable non-volatile memory module is provided, wherein the rewritable non-volatile memory module includes a plurality of physical erasing units, and each of the physical erasing units has an identical capacity. The memory control circuit unit includes a host interface, a memory interface and a memory management circuit. The host interface is configured to couple to a host system. The memory interface is configured to couple to the rewritable non-volatile memory module. The memory management circuit is coupled to the host interface and the memory interface, and configured to divide the physical erasing units into a first group and a second group, wherein the physical erasing units of the first group are not stored with valid data, and the physical erasing units of the second group are stored with the valid data. Further, the memory management circuit is further configured to record an erase count of each of the physical erasing units and arrange the physical erasing units of the second group according to the recorded erase counts. Furthermore, the memory management circuit is further configured to select one physical erasing unit from the physical erasing units of the first group as a first physical erasing unit according to the recorded erase counts, and select one physical erasing unit from the physical erasing units of the second group as a second physical erasing unit according to an arrangement sequence of the physical erasing units of the second group, wherein a valid data amount of the second physical erasing unit is less than the capacity. In addition, the memory management circuit is further configured to select another physical erasing unit having the valid data amount less than the capacity from the physical erasing units of the second group as a third physical erasing unit according to the arrangement sequence of the physical erasing units of the second group. Moreover, the memory management circuit is further configured to issue a command sequence for programming the valid data of the second physical erasing unit and at least part of the valid data of the third physical erasing unit into the first physical erasing unit.

According to an exemplary embodiment of the present invention, a memory storage device including a connection interface unit, a rewritable non-volatile memory module and a memory control circuit unit is provided. The connection interface unit is configured to couple to a host system. The rewritable non-volatile memory module includes a plurality of physical erasing units. The memory control circuit unit is coupled to the connection interface unit and the rewritable non-volatile memory module, and configured to divide the physical erasing units into a first group and a second group, wherein the physical erasing units of the first group are not stored with valid data, and the physical erasing units of the second group are stored with the valid data. Further, the memory control circuit unit is further configured to record an erase count of each of the physical erasing units and arrange the physical erasing units of the second group according to the recorded erase counts. Furthermore, the memory control circuit unit is further configured to select one physical erasing unit from the physical erasing units of the first group as a first physical erasing unit according to the recorded erase counts, and select one physical erasing unit from the physical erasing units of the second group as a second physical erasing unit according to an arrangement sequence of the physical erasing units of the second group, wherein a valid data amount of the second physical erasing unit is less than the capacity. In addition, the memory control circuit unit is further configured to select another physical erasing unit having the valid data amount less than the capacity from the physical erasing units of the second group as a third physical erasing unit according to the arrangement sequence of the physical erasing units of the second group. Moreover, the memory control circuit unit is further configured to issue a command sequence for programming the valid data of the second physical erasing unit and at least part of the valid data of the third physical erasing unit into the first physical erasing unit.

Based on the above, during the wear leveling operation, if one physical erasing unit having the valid data amount less than the capacity of one physical erasing unit is selected from the physical erasing unit stored with the valid data, the invention adopts the approach of skipping the physical erasing unit having the valid data amount not less than the capacity of one physical erasing unit among the physical erasing units stored with the valid data, so as to select multiple physical erasing units each having the valid data less than the capacity of one physical erasing unit from the physical erasing units stored with the valid data for performing the wear leveling operation on the selected physical erasing units together. As a result, the efficiency of the garbage collection may be effectively improved while ensuring that the speed of the sequential write operation may be maintained above the desired value.

To make the above features and advantages of the invention more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a host system, a memory storage device and an input/output (I/O) device according to an exemplary embodiment.

FIG. 2 is a schematic diagram illustrating a host system, a memory storage device and an input/output (I/O) device according to another exemplary embodiment.

FIG. 3 is a schematic diagram illustrating a host system and a memory storage device according to another exemplary embodiment.

FIG. 4 is a schematic block diagram illustrating a host system and a memory storage device according to an exemplary embodiment.

FIG. 5 is a schematic block diagram illustrating a memory control circuit unit according to an exemplary embodiment.

FIG. 6 and FIG. 7 are schematic diagrams illustrating a management of the physical erasing units according to an exemplary embodiment.

FIG. 8 is a schematic diagram illustrating the physical erasing units of the second group arranged according the erase counts according to an exemplary embodiment.

FIG. 9 is a schematic diagram illustrating selection of the second physical erasing unit for the wear leveling operation according to an exemplary embodiment.

FIG. 10 is a schematic diagram illustrating selection of the second physical erasing unit and the third physical erasing unit for the wear leveling operation according to an exemplary embodiment.

FIG. 11 is a flowchart of a wear leveling method according to an exemplary embodiment.

FIG. 12 is a flowchart of detailed steps for the selection of the third physical erasing unit in the wear leveling method according to an exemplary embodiment.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally, a memory storage device (also known as a memory storage system) includes a rewritable non-volatile memory module and a controller (also known as a control circuit unit). The memory storage device is usually configured together with a host system so that the host system may write data into the memory storage device or read data from the memory storage device.

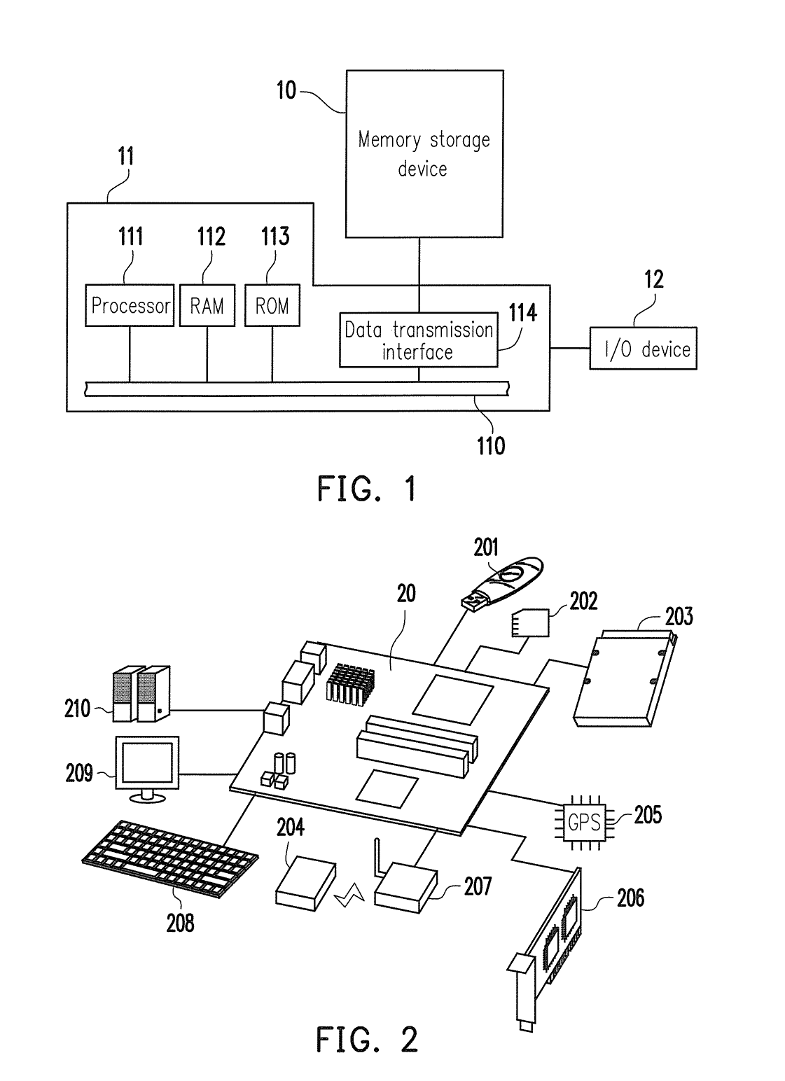

FIG. 1 is a schematic diagram illustrating a host system, a memory storage device and an input/output (I/O) device according to an exemplary embodiment, and FIG. 2 is a schematic diagram illustrating a host system, a memory storage device and an input/output (I/O) device according to another exemplary embodiment.

Referring to FIG. 1 and FIG. 2, a host system 11 generally includes a processor 111, a RAM (random access memory) 112, a ROM (read only memory) 113 and a data transmission interface 114. The processor 111, the RAM 112, the ROM 113 and the data transmission interface 114 are coupled to a system bus 110.

In the present exemplary embodiment, the host system 11 is coupled to a memory storage device 10 through the data transmission interface 114. For example, the host system 11 can write data into the memory storage device 10 or read data from the memory storage device 10 through the data transmission interface 114. Further, the host system 111 is coupled to an I/O device 12 through the system bus 110. For example, the host system 11 can transmit output signals to the I/O device 12 or receive input signals from I/O device 12 through the system bus 110.

In the present exemplary embodiment, the processor 111, the RAM 112, the ROM 113 and the data transmission interface 114 are disposed on a main board 20 of the host system 11. The number of the data transmission interface 114 may be one or more. Through the data transmission interface 114, the main board 20 may be coupled to the memory storage device 10 in a wired manner or a wireless manner. The memory storage device 10 may be, for example, a flash drive 201, a memory card 202, a SSD (Solid State Drive) 203 or a wireless memory storage device 204. The wireless memory storage device 204 may be, for example, a memory storage device based on various wireless communication technologies, such as a NFC (Near Field Communication Storage) memory storage device, a WiFi (Wireless Fidelity) memory storage device, a Bluetooth memory storage device, a BLE (Bluetooth low energy) memory storage device (e.g., iBeacon). Further, the main board 20 may also be coupled to various I/O devices including a GPS (Global Positioning System) module 205, a network interface card 206, a wireless transmission device 207, a keyboard 208, a monitor 209 and a speaker 210 through the system bus 110. For example, in an exemplary embodiment, the main board 20 can access the wireless memory storage device 204 through the wireless transmission device 207.

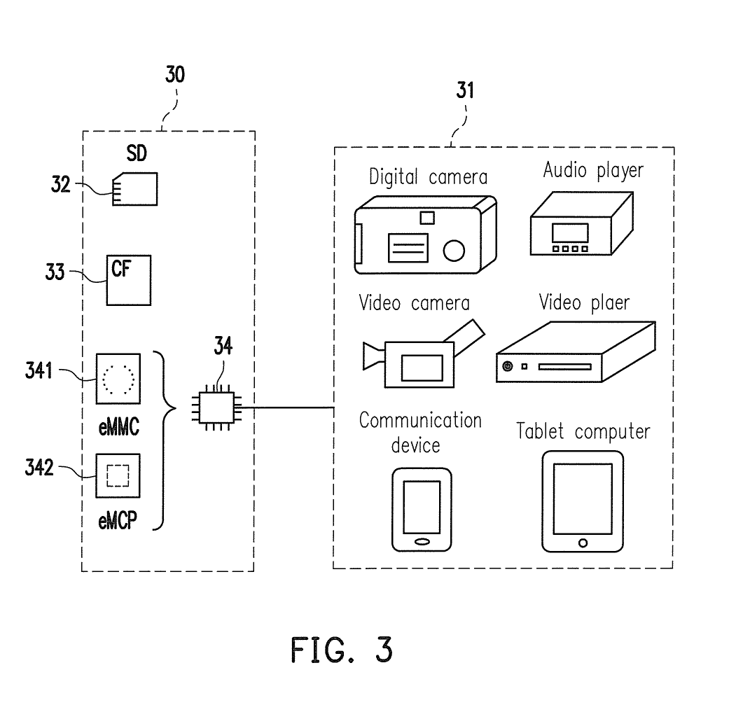

In an exemplary embodiment, aforementioned host system may be any systems capable of substantially cooperating with the memory storage device for storing data. Although the host system is illustrated as a computer system in foregoing exemplary embodiment; however, FIG. 3 is a schematic diagram illustrating a host system and a memory storage device according to another exemplary embodiment. Referring to FIG. 3, in another exemplary embodiment, a host system 31 may also be a system including a digital camera, a video camera, a communication device, an audio player, a video player or a tablet computer, whereas a memory storage device 30 can be various non-volatile memory devices used by the host system, such as a SD card 32, a CF card 33 or an embedded storage device 34. The embedded storage device 34 includes various embedded storage devices capable of directly coupling a memory module onto a substrate of the host system, such as an eMMC (embedded MMC) 341 and/or an eMCP (embedded Multi Chip Package) 342.

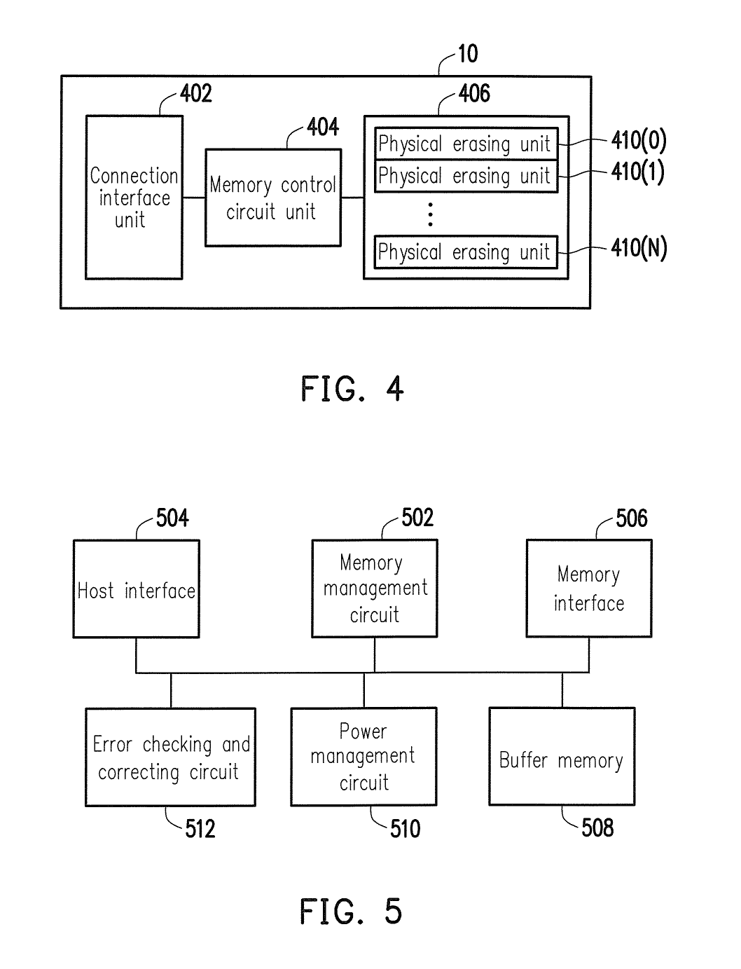

FIG. 4 is a schematic block diagram illustrating a host system and a memory storage device according to an exemplary embodiment.

Referring to FIG. 4, the memory storage device 10 includes a connection interface unit 402, a memory control circuit unit 404 and a rewritable non-volatile memory module 406.

In the present exemplary embodiment, the connection interface unit 402 is compatible with a SATA (Serial Advanced Technology Attachment) standard. Nevertheless, it should be understood that the invention is not limited thereto. The connection interface unit 402 may also be compatible to a PATA (Parallel Advanced Technology Attachment) standard, an IEEE (Institute of Electrical and Electronic Engineers) 1394 standard, a PCI Express (Peripheral Component Interconnect Express) interface standard, a USB (Universal Serial Bus) standard, a UHS-I (Ultra High Speed-I) interface standard, a UHS-II (Ultra High Speed-II) interface standard, a SD (Secure Digital) interface standard, a MS (Memory Stick) interface standard, a Multi-Chip Package interface standard, a MMC (Multi Media Card) interface standard, an eMMC (Embedded Multimedia Card) interface standard, a UFS (Universal Flash Storage) interface standard, an eMCP (embedded Multi Chip Package) interface standard, a CF (Compact Flash) interface standard, an IDE (Integrated Device Electronics) interface standard or other suitable standards. In this exemplary embodiment, the connection interface unit 402 and the memory control circuit unit 404 may be packaged into one chip, or the connection interface unit 402 is distributed outside of a chip containing the memory control circuit unit.

The memory control circuit unit 404 is configured to execute a plurality of logic gates or control instructions which are implemented in form of hardware or firmware, so as to perform operations of writing, reading or erasing data in the rewritable non-volatile memory storage module 406 according to the commands of the host system 11.

The rewritable non-volatile memory module 406 is coupled to the memory control circuit unit 404 and configured to store data written from the host system 11. The rewritable non-volatile memory storage module 406 includes multiple physical erasing units 410(0) to 410(N). For example, the physical erasing units 410(0) to 410(N) may belong to the same memory die or belong to different memory dies. Each physical erasing unit has a plurality of physical programming units, and the physical programming units of the same physical erasing unit may be written separately and erased simultaneously. Nevertheless, it should be understood that the invention is not limited thereto. Each physical erasing unit is composed by 64 physical programming units, 256 physical programming units or any amount of the physical programming units.

More specifically, the physical erasing unit is a minimum unit for erasing. Namely, each physical erasing unit contains the least number of memory cells to be erased together. The physical programming unit is the minimum unit for programming. That is, the programming unit is the minimum unit for writing data. Each physical programming unit usually includes a data bit area and a redundancy bit area. The data bit area having multiple physical access addresses is used to store user data, and the redundant bit area is used to store system data (e.g., control information and error checking and correcting code). In the present exemplary embodiment, each data bit area of the physical programming unit contains 8 physical access addresses, and the size of each physical access address is 512 byte. However, in other exemplary embodiments, the data bit area may also include more or less of the physical access addresses, and an amount and a size of the physical access addresses are not limited in the invention. For example, in one exemplary embodiment, the physical erasing unit is a physical block, and the physical programming unit is a physical page or a physical sector, but the invention is not limited thereto.

In the present exemplary embodiment, the rewritable non-volatile memory module 406 is a MLC (Multi Level Cell) NAND flash memory module (i.e., a flash memory module capable of storing two data bits in one memory cell). However, the disclosure is not limited thereto. The rewritable non-volatile memory module 406 may also be a SLC (Single Level Cell) NAND flash memory module, (i.e., a flash memory module capable of storing one data bit in one memory cell), a TLC (Trinary Level Cell) NAND flash memory module (i.e., a flash memory module capable of storing three data bits in one memory cell), other flash memory modules or any memory module having the same features.

FIG. 5 is a schematic block diagram illustrating a memory control circuit unit according to an exemplary embodiment.

Referring to FIG. 5, the memory control circuit unit 404 includes a memory management circuit 502, a host interface 504, a memory interface 506, a buffer memory 508, a power management circuit 510, and an error checking and correcting circuit 512.

The memory management circuit 502 is configured to control overall operations of the memory control circuit unit 404. Specifically, the memory management circuit 502 has a plurality of control instructions. During operations of the memory storage device 10, the control instructions are executed to execute various operations such as writing, reading and erasing data.

In this exemplary embodiment, the control instructions of the memory management circuit 502 are implemented in form of firmware. For instance, the memory management circuit 502 has a microprocessor unit (not illustrated) and a read-only memory (not illustrated), and the control instructions are burnt into the read-only memory. During the operations of the memory storage device 10, the control instructions are executed by the microprocessor to perform operations of writing, reading or erasing data.

In another exemplary embodiment of the invention, the control instructions of the memory management circuit 502 may also be stored into a specific area (for example, a system area in the memory module exclusively used for storing the system data) of the rewritable non-volatile memory module 406 as program codes. In addition, the memory management circuit 502 has a microprocessor unit (not illustrated), a ROM (not illustrated) and a RAM (not illustrated). Particularly, the ROM has a boot code, which is executed by the microprocessor unit to load the control instructions stored in the rewritable non-volatile memory module 406 to the RAM of the memory management circuit 502 when the memory control circuit unit 404 is enabled. Thereafter, the control instructions are executed by the microprocessor unit to execute operations of writing, reading or erasing data.

Further, in another exemplary embodiment, the control instructions of the memory management circuit 502 may also be implemented in a form of hardware. For example, the memory management circuit 502 includes a microprocessor, a memory cell management circuit, a memory writing circuit, a memory reading circuit, a memory erasing circuit and a data processing circuit. The memory cell management circuit, the memory writing circuit, the memory reading circuit, the memory erasing circuit and the data processing circuit are coupled to the microprocessor. The memory management circuit is configured to manage the physical erasing units of the rewritable non-volatile memory module 406; the memory writing circuit is configured to issue a write command to the rewritable non-volatile memory module 406 in order to write data into the rewritable non-volatile memory module 406; the memory reading circuit is configured to issue a read command to the rewritable non-volatile memory module 406 in order to read data from the rewritable non-volatile memory module 406; the memory erasing circuit is configured to issue an erase command to the rewritable non-volatile memory module 406 in order to erase data from the rewritable non-volatile memory module 406; the data processing circuit is configured to process both the data to be written to the rewritable non-volatile memory module 406 and the data to be read from the rewritable non-volatile memory module 406.

The host interface 504 is coupled to the memory management circuit 502 and configured to couple to the connection interface unit 402, so as to receive and identify commands and data sent from the host system 11. In other words, the commands and the data sent from the host system 11 are passed to the memory management circuit 502 through the host interface 504. In this exemplary embodiment, the host interface 504 is compatible with the SATA standard. However, it should be understood that the present invention is not limited thereto, and the host interface 504 may also be compatible with a PATA standard, an IEEE 1394 standard, a PCI Express standard, a USB standard, a UHS-I standard, a UHS-II standard, a SD standard, a MS standard, a MMC standard, a CF standard, an IDE standard, or other suitable standards for data transmission.

The memory interface 506 is coupled to the memory management circuit 502 and configured to access the rewritable non-volatile memory module 406. That is, data to be written to the rewritable non-volatile memory module 406 is converted to a format acceptable to the rewritable non-volatile memory module 406 through the memory interface 506.

The buffer memory 508 is coupled to the memory management circuit 502 and configured to temporarily store data and commands from the host system 11 or data from the rewritable non-volatile memory module 406.

The power management unit 510 is coupled to the memory management circuit 502 and configured to control a power of the memory storage device 10.

The error checking and correcting circuit 512 is coupled to the memory management circuit 502 and configured to execute an error checking and correcting process to ensure the correctness of data. Specifically, when the memory management circuit 502 receives a write command from the host system 11, the error checking and correcting circuit 512 generates an ECC code (Error Checking and Correcting Code) for data corresponding to the write command, and the memory management circuit 502 writes data and the ECC code corresponding to the write command into the rewritable non-volatile memory module 406. Subsequently, when the memory management circuit 502 reads the data from the rewritable non-volatile memory module 406, the error checking and correcting code corresponding to the data is also read, and the error checking and correcting circuit 512 may execute the error checking and correcting procedure for the read data according to the error checking and correcting code.

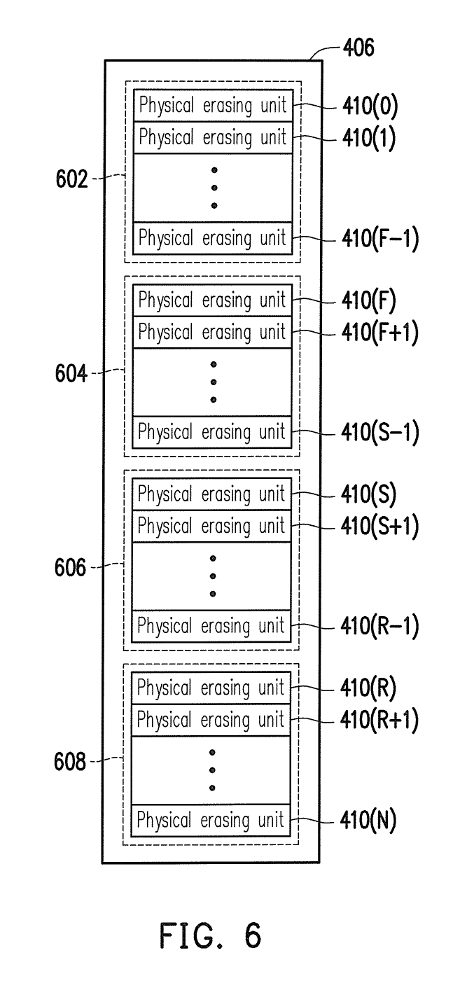

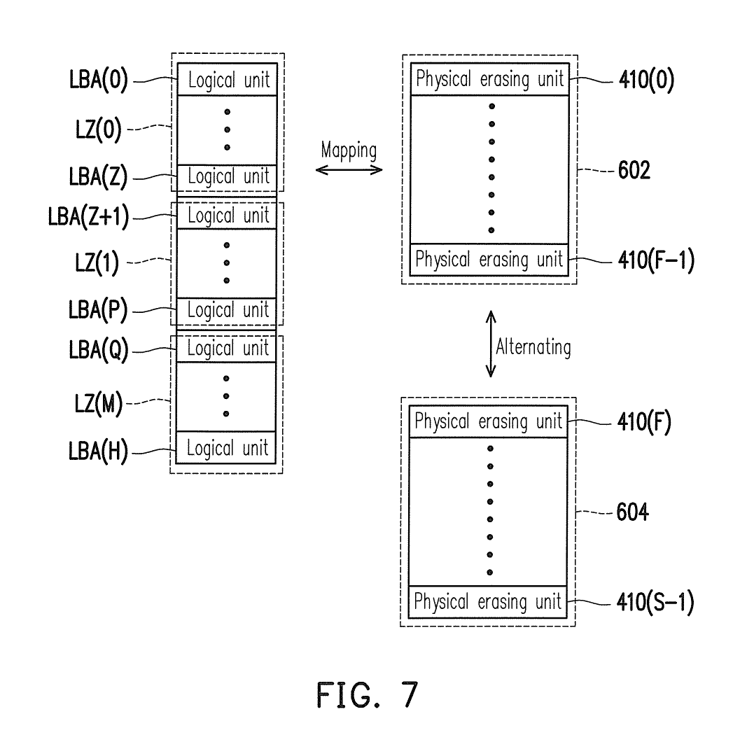

FIG. 6 and FIG. 7 are schematic diagrams illustrating a management of the physical erasing units according to an exemplary embodiment.

It should be understood that terms, such as “get”, “select”, “group”, “divide”, “associate” and so forth, are logical concepts which describe operations in the physical erasing units of the rewritable non-volatiles memory module 406. That is, the physical erasing units of the rewritable non-volatile memory module are logically operated, but actual positions of the physical units of the rewritable non-volatile memory module are not changed.

Referring to FIG. 6, the memory control circuit unit 404 (or the memory management circuit 502) may logically group the physical erasing units 410(0) to 410(N) into a data area 602, a spare area 604, a system area 606 and a replacement area 608.

The physical erasing units logically belonging to the data area 602 and the spare area 604 are configured to store data from the host system 11. More specifically, the physical erasing units of the data area 602 are regarded as the physical erasing units stored with the data, whereas the physical erasing units of the spare area 604 are configured to replace the physical erasing units of the data area 602. In other words, when the write command and the data to be written are received from the host system 11, the memory management unit 502 retrieves the physical erasing units from the spare area 604, and writes the data into the retrieved physical erasing units in order to replace the physical erasing units in the data area 602.

The physical erasing units logically belonging to the system area 606 are configured to record system data. For example, the system data includes information related to manufacturer and model of the rewritable non-volatile memory module, a number of physical erasing units in the rewritable non-volatile memory module, a number of the physical programming units in each physical erasing unit, and so forth.

The physical erasing units logically belonging to the replacement area 608 are used in a bad physical erasing unit replacement procedure for replacing damaged physical erasing units. More specifically, if the replacement area 608 still includes normal physical erasing units when the physical erasing units of the data area 602 are damaged, the memory management circuit 502 gets the normal physical erasing units from the replacement area 608 for replacing the damaged physical erasing units.

Particularly, the numbers of the physical erasing units in the data area 602, the spare area 604, the system area 606 and the replacement area 608 may be different from one another according to the different memory specifications. In addition, it should be understood that, during operations of the memory storage device 10, grouping relations of the physical erasing units for associating with the data area 602, the spare area 604, the system area 606, and the replacement area 608 may be dynamically changed. For example, when the damaged physical erasing units in the spare area 604 are replaced by the physical erasing units in the replacement area 608, the physical erasing units originally from the replacement area 608 are then associated with the spare area 604.

Referring to FIG. 7, the memory control circuit unit 404 (or the memory management circuit 502) is configured with logical units LBA(0) to LBA(H) for mapping the physical erasing units of the data area 602, wherein each of the logical units includes a plurality of logical sub units for mapping to the corresponding physical programming units of the physical erasing units. Further, when the host system 11 intends to write the data into the logical units or update the data stored in the logical units, the memory control circuit unit 404 (or the memory management circuit 502) selects one physical erasing units from the spare area 604 for writing the data as to alternate the physical erasing units of the data area 602. In the present exemplary embodiment, the logical sub-units may be logical pages or logical sectors.

In order to identify which of the physical erasing units is stored with the data of each logical unit, the memory control circuit unit 404 (or the memory management circuit 502) may record the mapping relations between the logical units and the physical erasing units in the present exemplary embodiment. Further, when the host system 11 intends to access the data in the logical sub-unit, the memory control circuit unit 404 (or the memory management circuit 502) confirms the logical unit to which the logical sub-unit belongs, and accesses the data in the physical erasing unit mapped to the logical unit. For instance, in the present exemplary embodiment, the memory control circuit unit 404 (or the memory management circuit 502) stores a logical-physical mapping table into the rewritable non-volatile memory module 406 for recording the physical erasing units mapped to each of the logical units, and loads the logical-physical mapping table into the buffer memory 508 for maintenance when the memory control circuit unit 404 (or the memory management circuit 502) intends to access the data.

It should be noted that, the mapping table cannot record the mapping relation for all of the logical units because a capacity of the buffer memory 508 is limited. Therefore, in the present exemplary embodiment, the memory control circuit unit 404 (or the memory management unit 502) groups the logical units LBA(0) to LBA(H) into a plurality of logical zones LZ(0) to LZ(M), and configures one logical-physical mapping table for each of the logical zones. In particular, when the memory control circuit unit 404 (or the memory management unit 502) intends to update the mapping table for one specific logical unit, the logical-physical mapping table corresponding to the logical zone to which the logical unit belongs is loaded into the buffer memory 508 for updating.

After the memory storage device 10 is operated for a while, the physical erasing units in the rewritable non-volatile memory module 406 may be divided into the physical erasing unit not stored with valid data (hereinafter, also known as the physical erasing units of a first group) and the physical erasing units stored with the valid data (hereinafter, also known as the physical erasing units of a second group). In general, the physical erasing units in the spare area 604 are the physical erasing units not stored with the valid data, whereas the physical erasing units in the data area 602 are stored with data after being operated by the user.

A write operation of the host system 11 may be roughly divided into a sequential write operation and a non-sequential write operation. The sequential write operation refers to that the logical addresses to be written by multiple write commands are sequential, and the opposite of the above is known as the non-sequential write operation. In other words, among the physical erasing units of the second group, the valid data stored by some physical erasing units belong to sequential logical addresses while the valid data stored by other physical erasing units belong to non-sequential logical addresses. In the present exemplary embodiment, each time when a write procedure belonging to the sequential write operation is performed, the physical erasing units for storing write-in data are filled by the valid data belonging to the sequential logical addresses. When the write procedure of the non-sequential write operation is performed, the memory control circuit unit 404 (or the memory management circuit 502) may continuously issue the write command for writing the data belonging to the non-sequential logical addresses into the physical programming units not stored with the valid data (also known as spare physical programming units) among the physical erasing units. When the host system 11 intends to update the data of one specific logical address, the memory control circuit unit 404 (or the memory management circuit 502) writes update data into the spare physical programming units, and marks the data stored by the physical programming unit originally mapped to the specific logical address as invalid data. Therefore, after the non-sequential write operation is performed for a while, the physical erasing units of the second group may include the physical erasing units stored with both the valid data and the invalid data. In other words, storage spaces of the physical erasing units stored with both the valid data and the invalid data are not fully stored with the valid data. In the present exemplary embodiment, the valid data in the physical erasing units not fully stored with the valid data may belong to non-sequential addresses. However, the invention is not limited thereto.

In the case where one specific physical erasing unit is not stored with the valid data (e.g., all of the stored data are marked as the invalid data), the memory control circuit unit 404 (or the memory management circuit 502) may perform an erase operation on the specific physical erasing unit in order to write the data therein again. In the present exemplary embodiment, the memory control circuit unit 404 (or the memory management circuit 502) records a corresponding erase count of each of the physical erasing units 410(0) to 410(N). Specifically, the erase count of each of the physical erasing units 410(0) to 410(N) is limited. For example, the physical erasing unit is damaged after being erased for ten thousand times. Further, when partial capacity loss in storage capacity or significant degradation in performance occurs due to wearing of the physical erasing units, the data stored by the user may be lost or the data cannot be stored at all. In particular, wearing of the physical erasing units depends on a program or erase count of each of the physical erasing units. In other words, if one physical erasing unit is merely programmed (or written) once without being programmed again afterwards, a wearing degree of such physical erasing unit is relatively low. Conversely, if one physical erasing unit is repeatedly programmed and erased, the wearing degree of such physical erasing unit is relatively high. For example, when one physical erasing unit in the rewritable non-volatile memory module 406 is erased, the memory control circuit unit 404 (or the memory management circuit 502) adds 1 to the erase count corresponding to such physical erasing unit. Herein, the erase count may be recorded into an erase count table or the corresponding physical erasing unit.

After the non-sequential write operation is performed for a while, the erase counts of a part of the physical erasing units may continue to increase due to the write procedure being repeatedly performed. In the present exemplary embodiment, when determining that the difference between the erase counts of the physical erasing units reaches a specific value, the memory control circuit unit 404 (or the memory management circuit 502) starts to perform the wear leveling operation. During the wear leveling operation, the memory control circuit unit 404 (or the memory management circuit 502) selects the physical erasing units for exchanging from the physical erasing units of the first group (i.e., the physical erasing unit not stored with the valid data) and the physical erasing units of the second group (i.e., the physical erasing unit stored with the valid data) according to the erase counts of the physical erasing units. For example, the memory control circuit unit 404 (or the memory management circuit 502) selects one physical erasing unit (hereinafter, also known as a first physical erasing unit) from the physical erasing units of the first group according to the erase counts and selects one physical erasing unit (hereinafter, also known as a second physical erasing unit) from the physical erasing units of the second group according to the erase counts.

In the present exemplary embodiment, the memory control circuit unit 404 (or the memory management circuit 502) selects the physical erasing unit having the greatest erase count from the physical erasing units of the first group as the first physical erasing unit. On the other hand, the memory control circuit unit selects one physical erasing unit having a smallest erase count from the physical erasing units of the second group as the second physical erasing unit. For instance, the memory control circuit unit 404 (or the memory management circuit 502) arranges the physical erasing units of the second group according to the erase count of the physical erasing units of the second group and records an arrangement sequence of the physical erasing units of the second group. Thereafter, the memory control circuit unit 404 (or the memory management circuit 502) selects the physical erasing unit from the beginning according to the arrangement sequence of the physical erasing units of the second group. For example, the physical erasing units of the second group are arranged in ascending order according to the erase counts. Accordingly, the memory control circuit unit 404 (or the memory management circuit 502) may then select the physical erasing unit according to the erase counts in the order from least to greatest. However, the erase count of the first physical erasing unit and the erase count of the second physical erasing unit may also be set with conditions different from the above based on actual requirements, which are not particularly limited by the present invention.

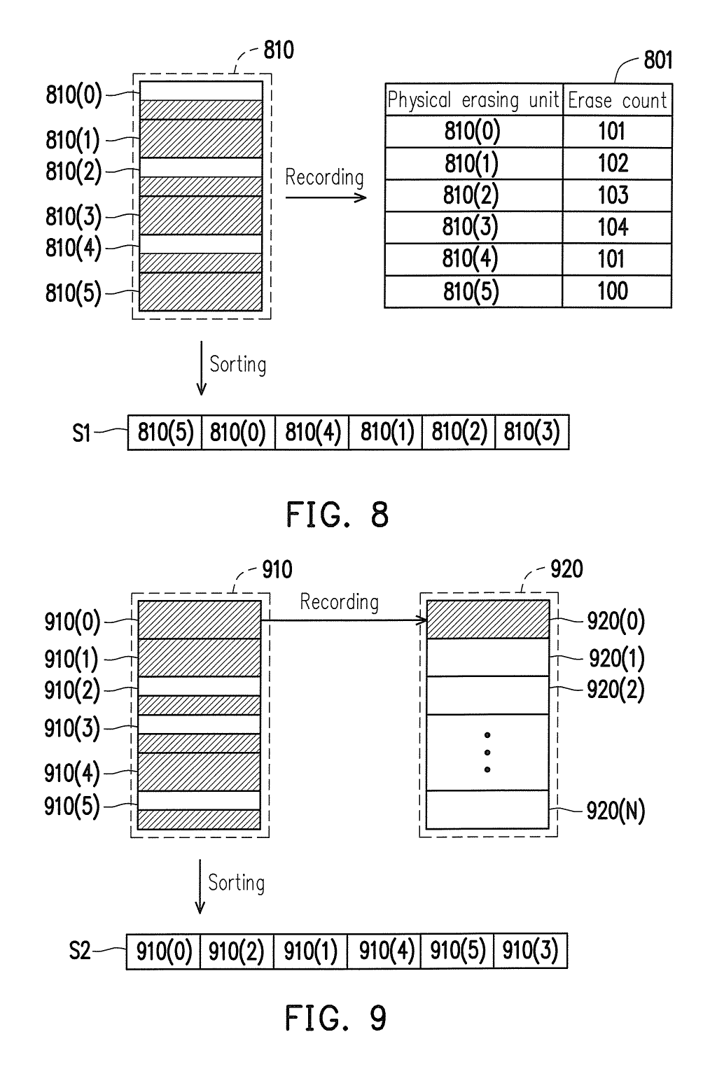

FIG. 8 is a schematic diagram illustrating the physical erasing units of the second group arranged according the erase counts according to an exemplary embodiment.

Referring to FIG. 8, physical erasing units 810(0) to 810(5) of a second group 810 are the physical erasing units stored with the valid data (the valid data stored in the physical erasing units are marked by slash lines). In the present exemplary embodiment, the erase counts of the physical erasing units 810(0) to 810(5) are recorded into an erase count table 801. The memory control circuit unit 404 (or the memory management circuit 502) arranges the physical erasing units 810(0) to 810(5) of the second group 810 in ascending order according to the erase counts recorded in the erase count table 801. As shown in FIG. 8, the physical erasing units 810(0) to 810(5) are arranged into an arrangement sequence S1. In other words, in the arrangement sequence S1, the physical erasing unit 810(5) arranged at the first place is the physical erasing unit having the smallest erase count among the physical erasing units 810(0) to 810(5) of the second group 810; the physical erasing unit 810(3) arranged at the last place is the physical erasing unit having the greatest erase count among the physical erasing units 810(0) to 810(5) of the second group 810. After the arrangement is completed, the memory control circuit unit 404 (or the memory management circuit 502) may select the physical erasing unit 810(5) arranged at the first place as the second physical erasing unit for the wear leveling operation according to the arrangement sequence S1.

Because the second group may include the physical erasing units stored with both the valid data and the invalid data, after selecting the second physical erasing unit from the second group, the memory control circuit unit 404 (or the memory management circuit 502) determines whether a valid data amount of the second physical erasing unit is less than a capacity of one physical erasing unit. Herein, the capacity of one physical erasing unit refers to a total amount of data that one physical erasing unit may be used for storing data, and the valid data amount of one physical erasing unit refers to an amount of the valid data stored in one physical erasing unit. In the present exemplary embodiment, each of the physical erasing units has the same capacity.

If the valid data amount of the second physical erasing unit is not less than (e.g., equal to) the capacity of one physical erasing unit, it means that the second physical erasing unit is stored with the valid data capable of filling one empty physical erasing unit. In this case, the memory control circuit unit 404 (or the memory management circuit 502) may issue a command sequence for directly writing the valid data of the second physical erasing unit into the first physical erasing unit and mark the valid data in the second physical erasing unit as the invalid data.

FIG. 9 is a schematic diagram illustrating selection of the second physical erasing unit for the wear leveling operation according to an exemplary embodiment.

Referring to FIG. 9, the memory control circuit unit 404 (or the memory management circuit 502) selects a physical erasing unit 920(0) from a first group 920 as the first physical erasing unit. In the present exemplary embodiment, it is assumed that physical erasing units 910(0) to 910(5) of a second group 910 have been arranged into an arrangement sequence S2. The memory control circuit unit 404 (or the memory management circuit 502) selects the physical erasing unit 910(0) as the second physical erasing unit according to the arrangement sequence S2. Because all of the physical programming units of the physical erasing unit 910(0) are stored with the valid data (i.e., the storage space of the physical erasing unit 910(0) is fully stored with the valid data), the memory control circuit unit 404 (or the memory management circuit 502) determines that a valid data amount D(0) of the physical erasing unit 910(0) is equal to (i.e., not less than) the capacity of one physical erasing unit. Accordingly, the memory control circuit unit 404 (or the memory management circuit 502) issues a command sequence for storing the valid data stored in the physical erasing unit 910(0) (i.e., the second physical erasing unit) into the physical erasing unit 920(0) (i.e., the first physical erasing unit) selected from first group 920.

On the other hand, if the valid data amount of the second physical erasing unit is less than the capacity of one physical erasing unit, it means that the second physical erasing unit is not stored with the valid data capable of filling one empty physical erasing unit. In other words, the storage space of the second physical erasing unit is not fully stored with the valid data. In this case, the memory control circuit unit 404 (or the memory management circuit 502) selects other physical erasing units from the second group in order to collect the valid data capable of filling one empty physical erasing unit. Specifically, the memory control circuit unit 404 (or the memory management circuit 502) selects another physical erasing unit from the second group as a candidate physical erasing unit according to the arrangement sequence of the physical erasing units of the second group. For example, the memory control circuit unit 404 (or the memory management circuit 502) sequentially selects one physical erasing unit arranged after the second physical erasing unit as the candidate physical erasing unit. Further, the memory control circuit unit 404 (or the memory management circuit 502) determines whether the valid data amount of the candidate physical erasing unit is less than the capacity of one physical erasing unit.

If the valid data amount of the current candidate physical erasing unit is not less than (e.g., equal to) the capacity of one physical erasing unit, it means that the current candidate physical erasing unit is stored with the valid data capable of filling one empty physical erasing unit. In this case, the memory control circuit unit 404 (or the memory management circuit 502) ignores the current candidate physical erasing unit and sequentially selects another physical erasing unit from the second group as the new candidate physical erasing unit. For example, the memory control circuit unit 404 (or the memory management circuit 502) sequentially selects one physical erasing unit arranged after the current candidate physical erasing unit as the new candidate physical erasing unit and performs the operation of determining whether the valid data amount of the candidate physical erasing unit is less than the capacity of one physical erasing unit again. In addition, if the valid data amount of the current candidate physical erasing unit is less than the capacity of one physical erasing unit, it means that the current candidate physical erasing unit is not stored with the valid data capable of filling one empty physical erasing unit. Accordingly, the memory control circuit unit 404 (or the memory management circuit 502) decides to use the current candidate physical erasing unit as a third physical erasing unit and issues a command sequence for writing the valid data of the second physical erasing unit and at least part of the valid data of the third physical erasing unit together into the first physical erasing unit.

It is worth mentioning that, the memory control circuit unit 404 (or the memory management circuit 502) also calculates whether a valid data amount sum of the valid data amount of the second physical erasing unit and the valid data amount of the third physical erasing unit and determines whether the valid data amount sum is less than the capacity of one physical erasing unit. In other words, the memory control circuit unit 404 (or the memory management circuit 502) determines the valid data to be written into the first physical erasing unit according to the valid data amount sum. For example, if the valid data amount sum is equal to the capacity of one physical erasing unit, the memory control circuit unit 404 (or the memory management circuit 502) issues a command sequence for writing all of the valid data of the second physical erasing unit and all of the valid data of the third physical erasing unit into the first physical erasing unit; if the valid data amount sum is greater than the capacity of one physical erasing unit, the memory control circuit unit 404 (or the memory management circuit 502) issues a command sequence for writing all of the valid data of the second physical erasing unit and part of the valid data of the third physical erasing unit into the first physical erasing unit. On the other hand, when the valid data amount sum is less than the capacity of one physical erasing unit, the memory control circuit unit 404 (or the memory management circuit 502) continues to select a suitable physical erasing unit (hereinafter, also known as a fourth physical erasing unit) from the second group in order to continue collecting the valid data. A method of selecting the fourth physical erasing unit is identical to the method of selecting the third physical erasing unit as described above, which is not repeated hereinafter.

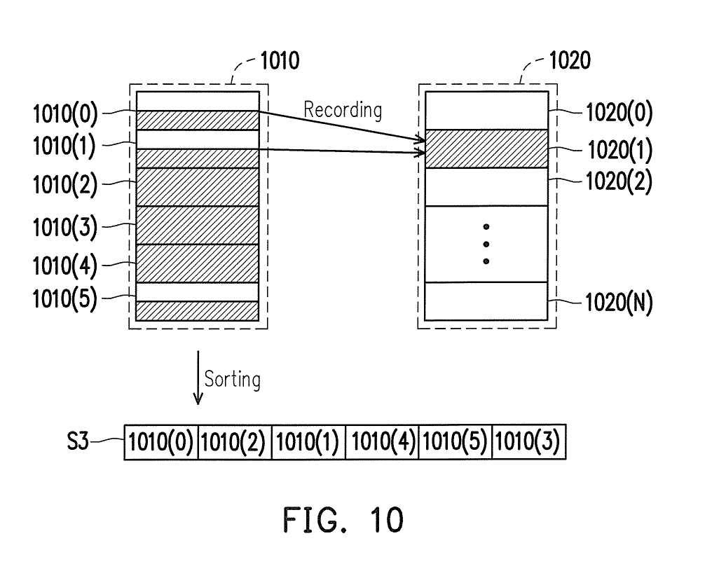

FIG. 10 is a schematic diagram illustrating selection of the second physical erasing unit and the third physical erasing unit for the wear leveling operation according to an exemplary embodiment.

Referring to FIG. 10, the memory control circuit unit 404 (or the memory management circuit 502) selects a physical erasing unit 1020(1) from a first group 1020 as the first physical erasing unit. It is assumed that physical erasing units 1010(0) to 1010(5) of a second group 1010 have been arranged into an arrangement sequence S3. The memory control circuit unit 404 (or the memory management circuit 502) selects the physical erasing unit 1010(0) as the second physical erasing unit according to the arrangement sequence S3. Because the physical erasing unit 1010(0) is stored with both the invalid data and the valid data (i.e., the storage space of the physical erasing unit 1010(0) is not fully stored with the valid data), the memory control circuit unit 404 (or the memory management circuit 502) determines that the valid data amount of the physical erasing unit 1010(0) is less than the capacity of one physical erasing unit. Accordingly, the memory control circuit unit 404 (or the memory management circuit 502) selects the physical erasing unit 1010(2) arranged after the physical erasing unit 1010(0) from the second group 1010 as a candidate physical erasing unit according to the arrangement sequence S3. However, because the valid data amount of the physical erasing unit 1010(2) is equal to the capacity of one physical erasing unit (i.e., all of the physical programming units therein are stored with the valid data), the memory control circuit unit 404 (or the memory management circuit 502) ignores the physical erasing unit 1010(2) and selects the physical erasing unit 1010(1) arranged after the physical erasing unit 1010(2) from the second group 1010 as the new candidate physical erasing unit according to the arrangement sequence S3. Because the valid data amount of the physical erasing unit 1010(1) is less than the capacity of one physical erasing unit, the memory control circuit unit 404 (or the memory management circuit 502) decides to use the physical erasing unit 1010(1) as the third physical erasing unit.

In the present exemplary embodiment, it is assumed that each of the valid data amount of the physical erasing unit 1010(0) and the valid data amount of the physical erasing unit 1010(1) is equal to one-half of the capacity of one physical erasing unit. In other words, the valid data amount sum of the valid data amount of the physical erasing unit 1010(0) and the valid data amount of the physical erasing unit 1010(1) is equal to the capacity of one physical erasing unit. Therefore, the memory control circuit unit 404 (or the memory management circuit 502) issues a command sequence for writing all of the valid data of the physical erasing unit 1010(0) and all of the valid data of the physical erasing unit 1010(1) together into the physical erasing unit 1020(1) selected from the first group 1020. Thereafter, the memory control circuit unit 404 (or the memory management circuit 502) may mark all of the valid data of the physical erasing unit 1010(0) and all of the valid data of the physical erasing unit 1010(1) as the invalid data.

In addition, in the present exemplary embodiment, if it is assumed that the valid data amount of the physical erasing unit 1010(0) is equal to one-half of the capacity of one physical erasing unit and the valid data amount of the physical erasing unit 1010(1) is equal to three-quarters of the capacity of one physical erasing unit, the valid data amount sum of the valid data amount of the physical erasing unit 1010(0) and the valid data amount of the physical erasing unit 1010(1) will be greater than the capacity of one physical erasing unit. Accordingly, the memory control circuit unit 404 (or the memory management circuit 502) issues a command sequence for writing all of the valid data of the physical erasing unit 1010(0) and part of the valid data of the physical erasing unit 1010(1) together into the physical erasing unit 1020(1) selected from the first group 1020. Thereafter, the memory control circuit unit 404 (or the memory management circuit 502) may mark all of the valid data of the physical erasing unit 1010(0) and the valid data of the physical erasing unit 1010(1) already written into the physical erasing unit 1020(0) as the invalid data.

Further, in the present exemplary embodiment, if it is assumed that the valid data amount of the physical erasing unit 1010(0) is equal to one-half of the capacity of one physical erasing unit and the valid data amount of the physical erasing unit 1010(1) is equal to one-quarter of the capacity of one physical erasing unit, the valid data amount sum of the valid data amount of the physical erasing unit 1010(0) and the valid data amount of the physical erasing unit 1010(1) will be less than the capacity of one physical erasing unit. Accordingly, the memory control circuit unit 404 (or the memory management circuit 502) selects the physical erasing unit 1010(4) arranged after the physical erasing unit 1010(1) from the second group 1010 as a candidate physical erasing unit according to the arrangement sequence S3. However, because the valid data amount of the physical erasing unit 1010(4) is equal to the capacity of one physical erasing unit (i.e., the storage space of the physical erasing unit 1010(4) is fully stored with the valid data), the memory control circuit unit 404 (or the memory management circuit 502) ignores the physical erasing unit 1010(4) and selects the physical erasing unit 1010(5) arranged after the physical erasing unit 1010(4) from the second group 1010 as the new candidate physical erasing unit according to the arrangement sequence S3. Because the valid data amount of the physical erasing unit 1010(5) is less than the capacity of one physical erasing unit, the memory control circuit unit 404 (or the memory management circuit 502) decides to use the physical erasing unit 1010(5) as the fourth physical erasing unit. It is assumed that the valid data amount of the physical erasing unit 1010(5) is equal to one-quarter of the capacity of one physical erasing unit. In other words, the valid data amount sum of the valid data amount of the physical erasing unit 1010(0), the valid data amount of the physical erasing unit 1010(1) and the valid data amount of the physical erasing unit 1010(5) is equal to the capacity of one physical erasing unit. Therefore, the memory control circuit unit 404 (or the memory management circuit 502) issues a command sequence for writing all of the valid data of the physical erasing unit 1010(0), all of the valid data of the physical erasing unit 1010(1) and all of the valid data of the physical erasing unit 1010(5) together into the physical erasing unit 1020(1) (not illustrated in the drawings) selected from the first group 1020. The memory control circuit unit 404 (or the memory management circuit 502) then marks all of the valid data of the physical erasing unit 1010(0), all of the valid data of the physical erasing unit 1010(1) and all of the valid data of the physical erasing unit 1010(5) as the invalid data.

In the foregoing exemplary embodiment, when the valid data amount of the second physical erasing unit is less than the capacity of one physical erasing unit, the memory control circuit unit 404 (or the memory management circuit 502) may also temporarily store the valid data of the second physical erasing unit and the valid data of the subsequently selected physical erasing units (e.g., the third physical erasing unit and the fourth physical erasing unit) into one temporary area (e.g., the buffer memory 508). When the valid data stored in the temporary area reaches (i.e., being greater than or equal to) the capacity of one physical erasing (i.e., when the valid data capable of filling one empty physical erasing unit is collected), the valid data in the temporary area may then be written into the first physical erasing unit. Furthermore, the physical erasing unit ignored during the process of selecting the third physical erasing unit (or the fourth physical erasing unit) may still be selected as the second physical erasing unit for the wear leveling operation in the future.

In other words, during the wear leveling operation, if the valid data amount of the second physical erasing unit is less than the capacity of one physical erasing unit, the memory control circuit unit 404 (or the memory management circuit 502) may continue to select the suitable physical erasing unit (i.e., the physical erasing unit having the valid data amount less than the capacity of one physical erasing unit) from the physical erasing units of the second group until the valid data amount sum of the selected physical erasing units is not less than the capacity of one physical erasing unit. Further, during the process of selecting the suitable physical erasing unit, the physical erasing unit having the valid data amount not less than the capacity of one physical erasing unit is ignored without being selected as the suitable physical erasing unit. When the valid data capable of filling one empty physical erasing unit is collected from the selected physical erasing units, the memory control circuit unit 404 (or the memory management circuit 502) decides the valid data to be written into the first physical erasing unit from the selected physical erasing units.

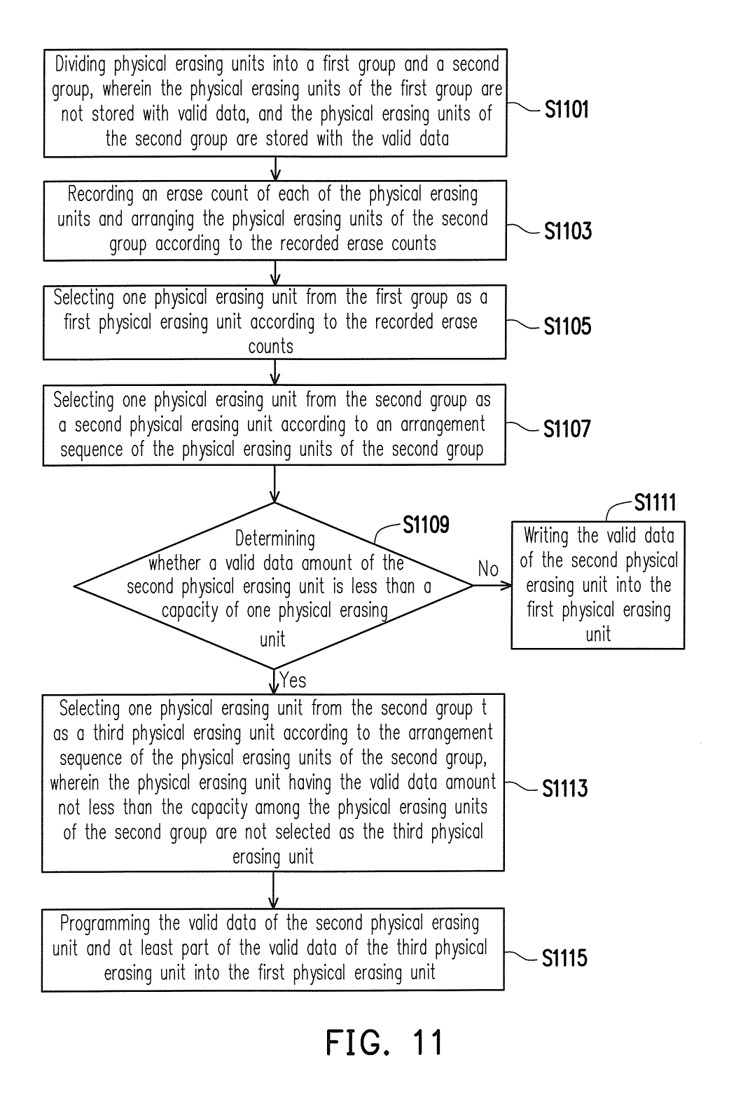

FIG. 11 is a flowchart of a wear leveling method according to an exemplary embodiment.

Referring to FIG. 11, in step S1101, the memory control circuit unit 404 (or the memory management circuit 502) divides physical erasing units into a first group and a second group. Herein, the physical erasing units of the first group are not stored with valid data, and the physical erasing units of the second group are stored with the valid data.

In step S1103, the memory control circuit unit (or the memory management circuit 502) records an erase count of each of the physical erasing units and arranges the physical erasing units of the second group according to the recorded erase counts.

In step S1105, the memory control circuit unit 404 (or the memory management circuit 502) selects one physical erasing unit from the first group as a first physical erasing unit according to the recorded erase counts.

In step S1107, the memory control circuit unit 404 (or the memory management circuit 502) selects one physical erasing unit from the second group as a second physical erasing unit according to an arrangement sequence of the physical erasing units of the second group.

In step S1109, the memory control circuit unit 404 (or the memory management circuit 502) determines whether a valid data amount of the second physical erasing unit is less than a capacity of one physical erasing unit.

If the valid data amount of the second physical erasing unit is not less than the capacity of one physical erasing unit, the memory control circuit unit 404 (or the memory management circuit 502) issues a command sequence for writing the valid data of the second physical erasing unit into the first physical erasing unit in step S1111.

If the valid data amount of the second physical erasing unit is less than the capacity of one physical erasing unit, the memory control circuit unit 404 (or the memory management circuit 502) selects one physical erasing unit from the second group as a third physical erasing unit according to the arrangement sequence of the physical erasing units of the second group in step S1113. Herein, the physical erasing unit having the valid data amount not less than the capacity among the physical erasing units of the second group are not selected as the third physical erasing unit. In other words, the memory control circuit unit 404 (or the memory management circuit 502) selects one physical erasing unit having the valid data amount less than the capacity of one physical erasing unit from the physical erasing units of the second group as the third physical erasing unit.

In step S1115, the memory control circuit unit 404 (or the memory management circuit 502) issues a command sequence for programming the valid data of the second physical erasing unit and at least part of the valid data of the third physical erasing unit into the first physical erasing unit.

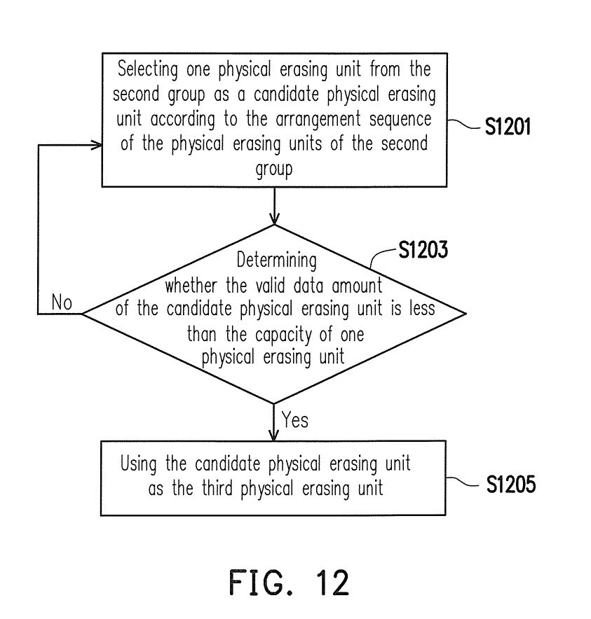

FIG. 12 is a flowchart of detailed steps for the selection of the third physical erasing unit in the wear leveling method according to an exemplary embodiment.

In step S1201, the memory control circuit unit 404 (or the memory management circuit 502) selects one physical erasing unit from the second group as a candidate physical erasing unit according to the arrangement sequence of the physical erasing units of the second group.

In step S1203, the memory control circuit unit 404 (or the memory management circuit 502) determines whether the valid data amount of the candidate physical erasing unit is less than the capacity of one physical erasing unit.

If the valid data amount of the candidate physical erasing unit is not less than the capacity of one physical erasing unit, the memory control circuit unit 404 (or the memory management circuit 502) performs step S1201 again.

If the valid data amount of the candidate physical erasing unit is less than the capacity of one physical erasing unit, in step S1205, the memory control circuit unit 404 (or the memory management circuit 502) uses the candidate physical erasing unit as the third physical erasing unit.

After step S1205 is completed, the memory control circuit unit 404 (or the memory management circuit 502) may further calculate a valid data amount sum and decides whether to continue selecting a suitable physical erasing unit according to the valid data amount sum. Details regarding the above have been described in the foregoing embodiments, and thus related descriptions are not repeated hereinafter.

In summary, the invention first selects one physical erasing unit from the physical erasing units stored with the valid data according to the number of the erase count for the wear leveling operation. If the valid data amount of the selected physical erasing unit is less than the capacity of one physical erasing unit, the invention further selects additional physical erasing unit from the physical erasing units stored with the valid data for the wear leveling operation. During the process of selecting the additional physical erasing unit, the physical erasing unit having the valid data amount not less than the capacity of one physical erasing unit among the physical erasing units stored with the valid data are not selected. As such, the valid data capable of filling one physical erasing unit may be collected from the physical erasing units in which the storage spaces are not fully stored with the valid data. Accordingly, the valid data written by the sequential write operation in the physical erasing units may be prevented from being written together with the valid data written by the non-sequential write operation into the same physical erasing unit during the wear leveling operation. As a result, the efficiency of the garbage collection may be improved while ensuring that the speed of the sequential write operation may be maintained above the desired value.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wear leveling method for a rewritable non-volatile memory module, wherein the rewritable non-volatile memory module comprises a plurality of physical erasing units, and each of the physical erasing units has an identical capacity, the wear leveling method comprising:
dividing the physical erasing units into a first group and a second group, wherein the physical erasing units of the first group are not stored with valid data and the physical erasing units of the second group are stored with the valid data;
recording an erase count of each of the physical erasing units and arranging the physical erasing units of the second group according to the recorded erase counts;
selecting one physical erasing unit from the physical erasing units of the first group as a first physical erasing unit according to the recorded erase counts;
selecting one physical erasing unit from the physical erasing units of the second group as a second physical erasing unit according to an arrangement sequence of the physical erasing units of the second group, wherein a valid data amount of the second physical erasing unit is less than the capacity;
selecting another physical erasing unit having the valid data amount less than the capacity from the physical erasing units of the second group as a third physical erasing unit according to the arrangement sequence of the physical erasing units of the second group; and
programming the valid data of the second physical erasing unit and at least part of the valid data of the third physical erasing unit into the first physical erasing unit.

2. The wear leveling method of claim 1, wherein the step of selecting the another physical erasing unit having the valid data amount less than the capacity from the physical erasing units of the second group as the third physical erasing unit according to the arrangement sequence of the physical erasing units of the second group comprises:
selecting one physical erasing unit from the physical erasing units of the second group according to the arrangement sequence of the physical erasing units of the second group as a candidate physical erasing unit and determining whether the valid data amount of the candidate physical erasing unit is less than the capacity;
selecting another physical erasing unit from the physical erasing units of the second group as the candidate physical erasing unit according to the arrangement sequence of the physical erasing units of the second group if the valid data amount of the candidate physical erasing unit is not less than the capacity; and
using the candidate physical erasing unit as the third physical erasing unit if the valid data amount of the candidate physical erasing unit is less than the capacity.

3. The wear leveling method of claim 1, wherein the step of programming the valid data of the second physical erasing unit and the at least part of the valid data of the third physical erasing unit into the first physical erasing unit comprises:
calculating a valid data amount sum according to the valid data amount of the second physical erasing unit and the valid data amount of the third physical erasing unit and determining whether the valid data amount sum is less than the capacity;
programming the valid data of the second physical erasing unit and the at least part of the valid data of the third physical erasing unit into the first physical erasing unit if the valid data amount sum is not less than the capacity;
selecting another physical erasing unit having the valid data amount less than the capacity from the physical erasing units of the second group as a fourth physical erasing unit according to the arrangement sequence of the physical erasing units of the second group if the valid data amount sum is less than the capacity; and
programming the valid data of the second physical erasing unit, the valid data of the third physical erasing unit and at least part of the valid data of the fourth physical erasing unit into the first physical erasing unit.

4. The wear leveling method of claim 1, wherein the step of arranging the physical erasing units of the second group according to the recorded erase counts comprises:
arranging the physical erasing units of the second group in ascending order according to the recorded erase counts.

5. The wear leveling method of claim 1, wherein the step of selecting the one physical erasing unit from the physical erasing units of the first group as the first physical erasing unit according to the recorded erase counts comprises:
selecting one physical erasing unit having a greatest erase count from the physical erasing units of the first group as the first physical erasing unit.

6. The wear leveling method of claim 1, wherein the valid data of the second physical erasing unit and the valid data of the third physical erasing unit belong to a plurality of non-sequential logical addresses.

7. A memory control circuit unit for controlling a rewritable non-volatile memory module, the rewritable non-volatile memory module having a plurality of physical erasing units, each of the physical erasing units having an identical capacity, the memory control circuit unit comprising:
a host interface configured to couple to a host system;
a memory interface configured to couple to the rewritable non-volatile memory module; and
a memory management circuit coupled to the host interface and the memory interface,
wherein the memory management circuit is configured to divide the physical erasing units into a first group and a second group, wherein the physical erasing units of the first group are not stored with valid data, and the physical erasing units of the second group are stored with the valid data,
wherein the memory management circuit is further configured to record an erase count of each of the physical erasing units and arrange the physical erasing units of the second group according to the recorded erase counts,
wherein the memory management circuit is further configured to select one physical erasing unit from the physical erasing units of the first group as a first physical erasing unit according to the recorded erase counts,
wherein the memory management circuit is further configured to select one physical erasing unit from the physical erasing units of the second group as a second physical erasing unit according to an arrangement sequence of the physical erasing units of the second group, wherein a valid data amount of the second physical erasing unit is less than the capacity,
wherein the memory management circuit is further configured to select another physical erasing unit having the valid data amount less than the capacity from the physical erasing units of the second group as a third physical erasing unit according to the arrangement sequence of the physical erasing units of the second group,
wherein the memory management circuit is further configured to issue a command sequence for programming the valid data of the second physical erasing unit and at least part of the valid data of the third physical erasing unit into the first physical erasing unit.

8. The memory control circuit unit of claim 7, wherein in the operation of selecting the another physical erasing unit having the valid data amount less than the capacity from the physical erasing units of the second group as the third physical erasing unit according to the arrangement sequence of the physical erasing units of the second group, the memory management circuit is further configured to select one physical erasing unit from the physical erasing units of the second group according to the arrangement sequence of the physical erasing units of the second group as a candidate physical erasing unit and determine whether the valid data amount of the candidate physical erasing unit is less than the capacity,
wherein the memory management circuit is further configured to select another physical erasing unit from the physical erasing units of the second group as the candidate physical erasing unit according to the arrangement sequence of the physical erasing units of the second group if the valid data amount of the candidate physical erasing unit is not less than the capacity,
wherein the memory management circuit is further configured to use the candidate physical erasing unit as the third physical erasing unit if the valid data amount of the candidate physical erasing unit is less than the capacity.

9. The memory control circuit unit of claim 7, wherein in the operation of issuing the command sequence for programming the valid data of the second physical erasing unit and the at least part of the valid data of the third physical erasing unit into the first physical erasing unit, the memory management circuit is further configured to calculate a valid data amount sum according to the valid data amount of the second physical erasing unit and the valid data amount of the third physical erasing unit and determine whether the valid data amount sum is less than the capacity,
wherein the memory management circuit is further configured to issue a command sequence for programming the valid data of the second physical erasing unit and the at least part of the valid data of the third physical erasing unit into the first physical erasing unit if the valid data amount sum is not less than the capacity,
wherein the memory management circuit is further configured to exclusively select another physical erasing unit having the valid data amount less than the capacity from the physical erasing units of the second group as a fourth physical erasing unit according to the arrangement sequence of the physical erasing units of the second group if the valid data amount sum is less than the capacity,
wherein the memory management circuit is further configured to issue a command sequence for programming the valid data of the second physical erasing unit, the valid data of the third physical erasing unit and at least part of the valid data of the fourth physical erasing unit into the first physical erasing unit.

10. The memory control circuit unit of claim 7, wherein in the operation of arranging the physical erasing units of the second group according to the recorded erase counts, the memory management circuit is further configured to arrange the physical erasing units of the second group in ascending order according to the recorded erase counts.

11. The memory control circuit unit of claim 7, wherein in the operation of selecting the one physical erasing unit from the physical erasing units of the first group as the first physical erasing unit according to the recorded erase counts, the memory management circuit is further configured to select one physical erasing unit having a greatest erase count from the physical erasing units of the first group as the first physical erasing unit.

12. The memory control circuit unit of claim 7, wherein the valid data of the second physical erasing unit and the valid data of the third physical erasing unit belong to a plurality of non-sequential logical addresses.

13. A memory storage device, comprising:
a connection interface unit configured to couple to a host system;
a rewritable non-volatile memory module comprising a plurality of physical erasing units; and
a memory control circuit unit coupled to the connection interface unit and the rewritable non-volatile memory module,
wherein the memory control circuit unit is configured to divide the physical erasing units into a first group and a second group, wherein the physical erasing units of the first group are not stored with valid data, and the physical erasing units of the second group are stored with the valid data,
wherein the memory control circuit unit is further configured to record an erase count of each of the physical erasing units and arrange the physical erasing units of the second group according to the recorded erase counts,
wherein the memory control circuit unit is further configured to select one physical erasing unit from the physical erasing units of the first group as a first physical erasing unit according to the recorded erase counts,
wherein the memory control circuit unit is further configured to select one physical erasing unit from the physical erasing units of the second group as a second physical erasing unit according to an arrangement sequence of the physical erasing units of the second group, wherein a valid data amount of the second physical erasing unit is less than the capacity,
wherein the memory control circuit unit is further configured to select another physical erasing unit having the valid data amount less than the capacity from the physical erasing units of the second group as a third physical erasing unit according to the arrangement sequence of the physical erasing units of the second group,
wherein the memory control circuit unit is further configured to program the valid data of the second physical erasing unit and at least part of the valid data of the third physical erasing unit into the first physical erasing unit.

14. The memory storage device of claim 13, wherein in the operation of selecting the another physical erasing unit having the valid data amount less than the capacity from the physical erasing units of the second group as the third physical erasing unit according to the arrangement sequence of the physical erasing units of the second group, the memory control circuit unit is further configured to select one physical erasing unit from the physical erasing units of the second group according to the arrangement sequence of the physical erasing units of the second group as a candidate physical erasing unit and determine whether the valid data amount of the candidate physical erasing unit is less than the capacity,
wherein the memory control circuit unit is further configured to select another physical erasing unit from the physical erasing units of the second group as the candidate physical erasing unit according to the arrangement sequence of the physical erasing units of the second group if the valid data amount of the candidate physical erasing unit is not less than the capacity,
wherein the memory control circuit unit is further configured to use the candidate physical erasing unit as the third physical erasing unit if the valid data amount of the candidate physical erasing unit is less than the capacity.

15. The memory storage device of claim 13, wherein in the operation of programming the valid data of the second physical erasing unit and the at least part of the valid data of the third physical erasing unit into the first physical erasing unit, wherein the memory control circuit unit is further configured to calculate a valid data amount sum according to the valid data amount of the second physical erasing unit and the valid data amount of the third physical erasing unit and determine whether the valid data amount sum is less than the capacity,
wherein the memory control circuit unit is further configured to program the valid data of the second physical erasing unit and the at least part of the valid data of the third physical erasing unit into the first physical erasing unit if the valid data amount sum is not less than the capacity,
wherein the memory control circuit unit is further configured to select another physical erasing unit having the valid data amount less than the capacity from the physical erasing units of the second group as a fourth physical erasing unit according to the arrangement sequence of the physical erasing units of the second group if the valid data amount sum is less than the capacity,
wherein the memory control circuit unit is further configured to program the valid data of the second physical erasing unit, the valid data of the third physical erasing unit and at least part of the valid data of the fourth physical erasing unit into the first physical erasing unit.

16. The memory storage device of claim 13, wherein in the operation of arranging the physical erasing units of the second group according to the recorded erase counts, the memory control circuit unit is further configured to arrange the physical erasing units of the second group in ascending order according to the recorded erase counts.

17. The memory storage device of claim 13, wherein in the operation of selecting the one physical erasing unit from the physical erasing units of the first group as the first physical erasing unit according to the recorded erase counts, the memory control circuit unit is further configured to select one physical erasing unit having a greatest erase count from the physical erasing units of the first group as the first physical erasing unit.

18. The memory storage device of claim 13, wherein the valid data of the second physical erasing unit and the valid data of the third physical erasing unit belong to a plurality of non-sequential logical addresses.
